(19) United States
(12) Patent Application Publication
(10) Pub. No.: US 2008/0025168 A1
(43) Pub. Date: Jan. 31, 2008

(54) METHODS FOR DETERMINING RELATIONSHIP BETWEEN MAIN BEAM AND SIDE BEAM IN OPTICAL STORAGE DEVICE AND RELATED APPARATUSES

(76) Inventor: Chi-Mou Chao, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/460,255

(22) Filed: Jul. 27, 2006

(51) Int. Cl. G11B 7/00

(52) U.S. Cl. 369/44.37; 369/124.03

(57) ABSTRACT

Methods and apparatuses for determining a relationship between a main beam and a side beam are provided. One proposed method includes: measuring reflected light of the side beam under a first laser power to generate a first value; measuring reflected light of the main beam under the first laser power to generate a second value; measuring reflected light of the side beam under a second laser power to generate a third value; measuring reflected light of the main beam under the second laser power to generate a fourth value; and determining a ratio of the main beam to the side beam according to the first, second, third, and fourth values. Once the ratio α of the main beam to the side beam is determined, at least one servo control signal can be generated accordingly.

### BACKGROUND

The present disclosure relates to optical storage techniques, and more particularly, to methods and apparatuses for determining relationship between a main beam and a side beam, and associated methods and apparatuses for generating a servo control signal.

Conventionally, the ratio of the main beam to the side beam of a pick-up head of an optical disc drive is provided by the manufacturer of the pick-up head. As is well known in the art, the ratio of the main beam to the side beam is a very important parameter for generation of some servo control signals, such as a tracking error (TE) signal, a focusing error (FE) signal, or a differential radial contrast (DRC) signal.

However, the actual ratio of the main beam to the side beam of each pick-up head may differ from that provided by the manufacturer due to the process deviation. As a result, the servo control performance of the optical disc drive may be detrimentally affected.

### SUMMARY

An exemplary embodiment of a method for determining a relationship between a main beam and a side beam in an optical storage device is disclosed comprising: measuring reflected light of the side beam under a first laser power to generate a first value; measuring reflected light of the main beam under the first laser power to generate a second value; measuring reflected light of the side beam under a second laser power to generate a third value; measuring reflected light of the main beam under the second laser power to generate a fourth value; and determining a ratio of the main beam to the side beam according to the first, second, third, and fourth values.

An exemplary embodiment of an optical storage device for determining a relationship between a main beam and a side beam is disclosed comprising: a measuring module for measuring reflected light of the side beam under a first laser power to generate a first value, measuring reflected light of the main beam under the first laser power to generate a second value, measuring reflected light of the side beam under a second laser power to generate a third value, and measuring reflected light of the main beam under the second laser power to generate a fourth value; and a decision unit coupled to the measuring module for determining a ratio of the main beam to the side beam according to the first, second, third, and fourth values.

An exemplary embodiment of a method for generating at lease one servo control signal of an optical storage device is disclosed comprising: measuring reflected light of the side beam under a first laser power to generate a first value; measuring reflected light of the main beam under the first laser power to generate a second value; measuring reflected light of the side beam under a second laser power to generate a third value; measuring reflected light of the main beam under the second laser power to generate a fourth value; determining a ratio of the main beam to the side beam according to the first, second, third, and fourth values; generating a first push-pull signal according to reflected light of the main beam; generating a second push-pull signal according to reflected light of the side beam; and generating the servo control signal according to the first push-pull signal, the second push-pull signal, and the ratio.

An exemplary embodiment of an optical storage device for generating at lease one servo control signal is disclosed comprising: a measuring module for measuring reflected light of the side beam under a first laser power to generate a first value, measuring reflected light of the main beam under the first laser power to generate a second value, measuring reflected light of the side beam under a second laser power to generate a third value, and measuring reflected light of the main beam under the second laser power to generate a fourth value; a decision unit coupled to the measuring module for determining a ratio of the main beam to the side beam according to the first, second, third, and fourth values; a first push-pull signal generator for generating a first push-pull signal according to reflected light of the main beam; a second push-pull signal generator for generating a second push-pull signal according to reflected light of the side beam; and a servo control signal generator for generating the servo control signal according to the first push-pull signal, the second push-pull signal, and the ratio.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram of an optical storage device according to an exemplary embodiment.

FIG. 2 is a schematic diagram illustrating the corresponding positions of the detection signals A through H with respect to a photo detector of FIG. 1.

FIG. 3 is a flowchart illustrating a method for determining relationship between the main beam and the side beam according to an exemplary embodiment.

FIG. 4 is a schematic diagram illustrating the relationship between amplitudes of the main beam sum signal and the side beam sum signal of FIG. 1 with respect to different laser power levels.

FIG. 5 is a simplified block diagram of a servo control signal generator according to a first embodiment.

FIG. 6 is a simplified block diagram of a servo control signal generator according to a second embodiment.

FIG. 7 is a simplified block diagram of a servo control signal generator according to a third embodiment.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

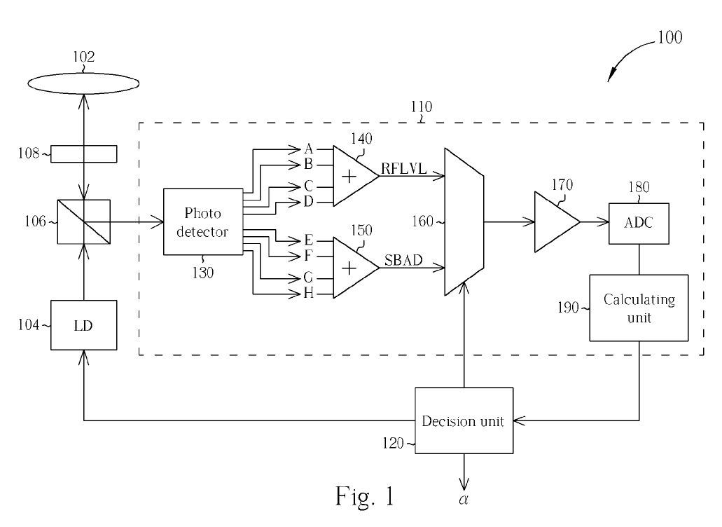

Please refer to FIG. 1, which shows a simplified block diagram of an optical storage device 100 according to an exemplary embodiment. As shown, the optical storage device 100 comprises: an optical disc 102, a laser diode 104, a beam splitter 106, an objective lens 108, a measuring module 110, and a decision unit 120. The operations of the laser diode 104, the beam splitter 106, and the objective lens 108 are well known in the art, further details are therefore omitted herein for the sake of brevity. In the optical storage device 100, the measuring module 110 is arranged for measuring reflected light of the main beam and reflected light of the side beam. The decision unit 120 then calculates a ratio α of the main beam to the side beam according to the measuring results of the measuring module 110.

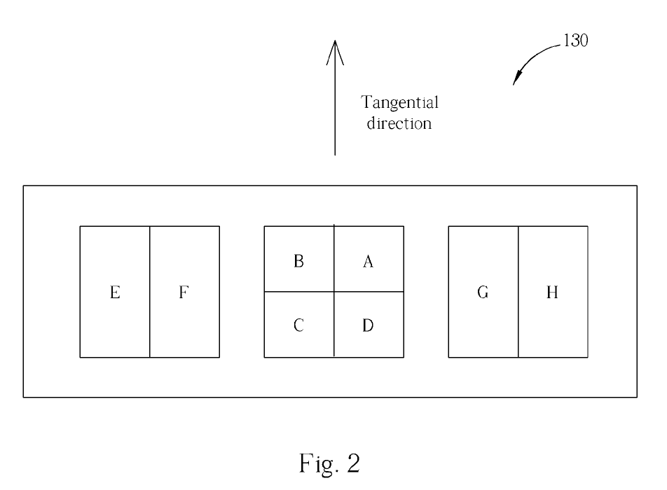

As shown in FIG. 1, the measuring module 110 of this embodiment comprises a photo detector 130, two operating units 140 and 150, a signal selector 160, a gain stage 170, an analog-to-digital converter (ADC) 180, and a calculating unit 190. The photo detector 130 is arranged for detecting light reflected from the optical disc 102 to generate detection signals A, B, C, D, E, F, G, and H, wherein the detection signals A through D correspond to the reflected light of the main beam while the detection signals E through H correspond to the reflected light of the side beam. The corresponding positions of the detection signals A through H with respect to the photo detector 130 are illustrated in FIG. 2. In practice, the photo detector 130 may be implemented by a photo detector integrated circuit (PDIC). The first operating unit 140 is arranged for generating a main beam sum signal RFLVL according to the detection signals A through D, and the second operating unit 150 is arranged for generating a side beam sum signal SBAD according to the detection signals E through H. In practice, the signal selector 160 may be a multiplexer for selectively outputting either the main beam sum signal RFLVL or the side beam sum signal SBAD as an output signal. The gain stage 170 is arranged for amplifying the output signal of the signal selector 160. In this embodiment, the ADC 180 converts the amplified output signal from the gain stage 170 into digital values, and the calculating unit 190 then calculates a value corresponding to the reflected light of the side beam or the main beam under a specific laser power according to the digital values.

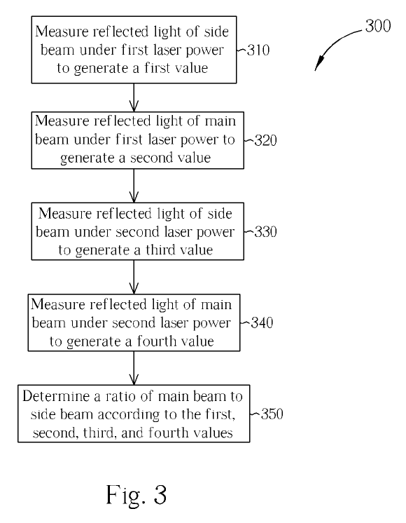

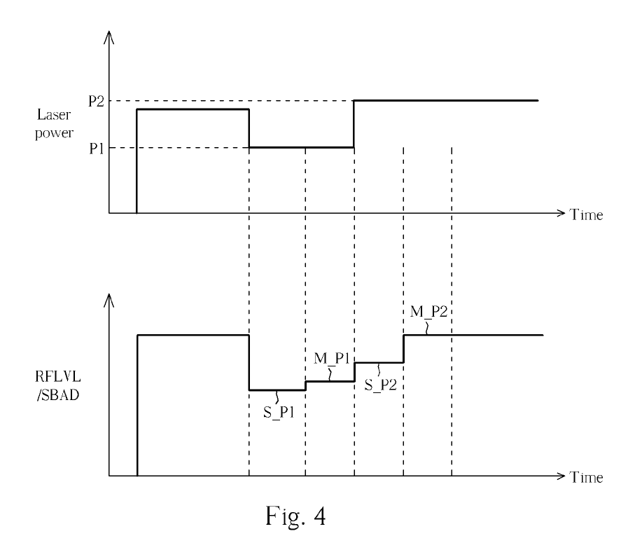

According to the foregoing descriptions, it can be appreciated that the combination of the photo detector 130, the two operating units 140 and 150, the signal selector 160, and the gain stage 170 can be regarded as a sensing device for sensing the reflected light of the main beam/side beam to generate a corresponding analog signal. Hereinafter, the operations of the measuring module 110 and decision unit 120 will be described with reference to FIG. 3 and FIG. 4.

FIG. 3 is a flowchart 300 illustrating a method for determining the relationship between the main beam and the side beam according to an exemplary embodiment.

In step 310, the measuring module 110 measures reflected light of the side beam under a first laser power P1 to generate a first value S_P1. Specifically, the decision unit 120 controls the laser diode 104 to emit light using the first laser power P1, and the photo detector 130 of the measuring module 110 detects the light reflected from the optical disc 102. In addition, the decision unit 120 controls the signal selector 160 to select the side beam sum signal SBAD corresponding to the first laser power P1 as the output signal in step 310. In this embodiment, the ADC 180 generates a plurality of first digital values corresponding to the side beam sum signal SBAD under the first laser power P1, and the calculating unit 190 averages the plurality of first digital values to generate the first value S_P1.

In step 320, the measuring module 110 measures reflected light of the main beam under the first laser power P1 to generate a second value M_P1. In this step, the decision unit 120 controls the signal selector 160 to select the main beam sum signal RFLVL corresponding to the first laser power P1 as the output signal. Accordingly, the ADC 180 generates a plurality of second digital values corresponding to the main beam sum signal RFLVL under the first laser power P1, and the calculating unit 190 then averages the plurality of second digital values to generate the second value M_P1.

In one aspect, the first value S_P1 corresponds to DC component of the reflected light of the side beam under the first laser power P1, and the second value M_P1 corresponds to DC component of the reflected light of the main beam under the first laser power P1.

In step 330, the measuring module 110 measures reflected light of the side beam under a second laser power P2 to generate a third value S_P2. In this embodiment, the decision unit 120 controls the laser diode 104 to emit light using the second laser power P2, and controls the signal selector 160 to select the side beam sum signal SBAD corresponding to the second laser power P2 as the output signal in step 330. As a result, the ADC 180 generates a plurality of third digital values corresponding to the side beam sum signal SBAD under the second laser power P2, and the calculating unit 190 averages the plurality of third digital values to generate the third value S_P2, which corresponds to DC component of the reflected light of the side beam under the second laser power P2.

In step 340, the measuring module 110 measures reflected light of the main beam under the second laser power P2 to generate a fourth value M_P2. Similar to step 320, the decision unit 120 controls the signal selector 160 to select the main beam sum signal RFLVL corresponding to the second laser power P2 as the output signal in step 340. Therefore, the ADC 180 generates a plurality of fourth digital values corresponding to the main beam sum signal RFLVL under the second laser power P2, and the calculating unit 190 averages the plurality of fourth digital values to generate the fourth value M_P2, which corresponds to DC component of the reflected light of the main beam under the second laser power P2. The relationship between amplitudes of the main beam sum signal RFLVL and the side beam sum signal SBAD with respect to different laser power levels is illustrated in FIG. 4.

In step 350, the decision unit 120 determines a ratio α of the main beam to the side beam according to the first value S_P1, the second value M_P1, the third value S_P2, and the fourth value M_P2 generated by the calculating unit 190. In a preferred embodiment, the decision unit 120 determines the ratio α in accordance with the following formula:

α=(M_{—}P2−M_{—}P1)/(S_{—}P2−S_{—}P1) (1)

As in the foregoing illustrations, the optical storage device 100 can obtain the actual ratio of the main beam to the side beam by changing the laser power of the laser diode 104 without performing complicated mechanical operations.

Please note that separate functional blocks shown in FIG. 1 may be realized by a same component in practical implementations. For example, the calculating unit 190 and the decision unit 120 can be realized by a same controller of the optical storage device 100, such as the microprocessor.

In the aforementioned embodiment, the measuring module 110 performs steps 310 and 320 in sequence to generate the first value S_P1 and the second value M_P1, and performs steps 330 and 340 in sequence to generate the third value S_P2 and the fourth value M_P2. This is merely an example rather than a restriction of the practical implementations. In practice, the measuring module 110 can also utilize duplicate gain stages and ADCs so as to measure reflected light of the side beam and reflected light of the main beam under a predetermined laser power in parallel. In other words, the order of the flowchart 300 is merely an example for illustrative purpose rather than a restriction of the practical implementations.

As mentioned above, once the actual ratio α of the main beam to the side beam is obtained, reliable servo control signals can be generated accordingly.

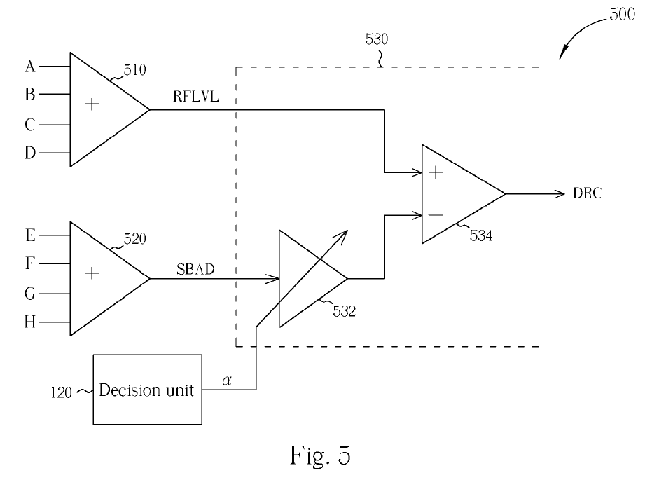

Please refer to FIG. 5, which shows a simplified block diagram of a servo control signal generator 500 according to a first embodiment. In this embodiment, the servo control signal generator 500 comprises: the decision unit 120 for providing the ratio α of the main beam to the side beam; a first summing signal generator 510 for generating a first summing signal RFLVL=(A+B+C+D) according to reflected light of the main beam; a second summing signal generator 520 for generating a second summing signal SBAD=(E+F+G+H) according to reflected light of the side beam; and a servo control signal generator 530 for generating a differential radial contrast signal DRC according to the first summing signal RFLVL, the second summing signal SBAD, and the ratio α.

In a preferred embodiment, the servo control signal generator 530 comprises a first gain stage 532 and a second gain stage 534 as shown in FIG. 5. The servo control signal generator 530 of this embodiment generates the differential radial contrast signal DRC according to the following formula:

DRC=K_{DRC}*[(A+B+C+D)−α*(E+F+G+H)] (2)

where the ratio α of the main beam to the side beam is the gain of the first gain stage 532, and K_{DRC} is the gain of the second gain stage 534. In this case, the gain K_{DRC} is utilized for adjusting the DC level of the differential radial contrast signal DRC to a desired value.

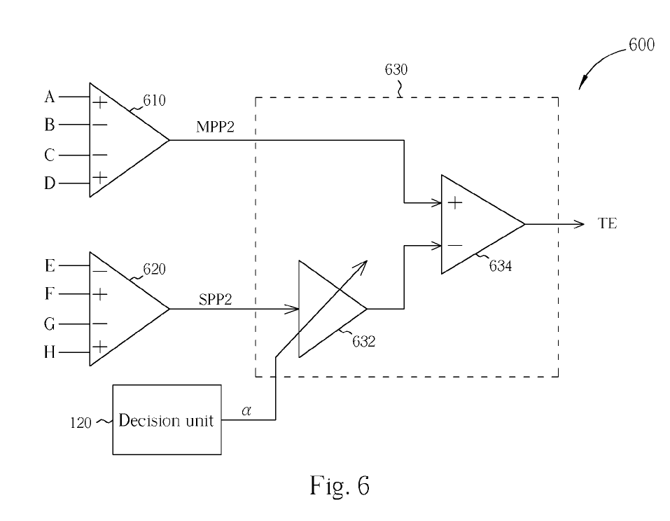

FIG. 6 is a simplified block diagram of a servo control signal generator 600 according to a second embodiment. In this embodiment, the servo control signal generator 600 comprises: the decision unit 120 for providing the ratio α of the main beam to the side beam; a first push-pull signal generator 610 for generating a first push-pull signal MPP2=(A+D)−(B+C) according to reflected light of the main beam; a second push-pull signal generator 620 for generating a second push-pull signal SPP2=(F+H)−(E+G) according to reflected light of the side beam; and a servo control signal generator 630 for generating a tracking error signal TE according to the first push-pull signal MPP2, the second push-pull signal SPP2, and the ratio α.

In a preferred embodiment, the servo control signal generator 630 comprises a first gain stage 632 and a second gain stage 634 as shown in FIG. 6. The servo control signal generator 630 of this embodiment generates the tracking error signal TE according to the following formula:

TE=K_{TE}*{[(A+D)−(B+C)]−α*[(F+H)−(E+G)]} (3)

where the ratio α of the main beam to the side beam is the gain of the first gain stage 632, and K_{TE} is the gain of the second gain stage 634. Similarly, the gain K_{TE} is utilized for adjusting the DC level of the tracking error signal TE to a desired value.

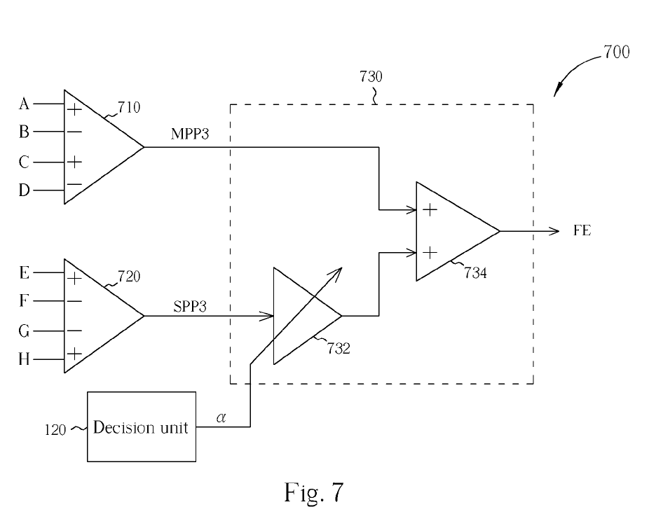

Please refer to FIG. 7, which shows a simplified block diagram of a servo control signal generator 700 according to a third embodiment. The servo control signal generator 700 comprises: the decision unit 120 for providing the ratio α of the main beam to the side beam; a first push-pull signal generator 710 for generating a first push-pull signal MPP3=(A+C)−(B+D) according to reflected light of the main beam; a second push-pull signal generator 720 for generating a second push-pull signal SPP3=(E+H)−(F+G) according to reflected light of the side beam; and a servo control signal generator 730 for generating a focusing error signal FE according to the first push-pull signal MPP3, the second push-pull signal SPP3, and the ratio α. The servo control signal generator 730 includes a first gain stage 732 and a second gain stage 734 as shown in FIG. 7. The servo control signal generator 730 of this embodiment generates the focusing error signal FE according to the following formula:

FE=K_{FE}*{[(A+C)−(B+D)]+α*[(E+H)−(F+G)]} (4)

where the ratio α of the main beam to the side beam is the gain of the first gain stage 732, and K_{FE} is the gain of the second gain stage 734. In this case, the gain K_{FE} is utilized for adjusting the DC level of the focusing error signal FE to a desired value.

Those skilled in the art will readily observe that numerous modifications and alterations of the device and method may be made while retaining the teachings of the invention. Accordingly, the above disclosure should be construed as limited only by the metes and bounds of the appended claims.

1. A method for determining a relationship between a main beam and a side beam in an optical storage device, the method comprising:
measuring reflected light of the side beam under a first laser power to generate a first value;
measuring reflected light of the main beam under the first laser power to generate a second valise;
measuring reflected light of the side beam under a second laser power to generate a third value;
measuring reflected light of the main beam under the second laser power to generate a fourth value; and
determining a ratio of the main beam to the side beam according to the first, second, third, and fourth values.

2. The method of claim 1, wherein the step of determining the ratio comprises:
calculating a first difference between the first and third values:
calculating a second difference between the second and fourth values; and
calculating the ratio according to the first and second differences.

3. The method of claim 2, wherein the step of calculating the ratio according to the first and second differences comprises:
dividing the first difference by the second difference to generate the ratio.

4. The method of claim 1, wherein the first value corresponds to DC component of the reflected light of the side beam under the first laser power and the third value corresponds to DC component of the reflected light of the side beam under the second laser power.

5. The method of claim 1, wherein the second value corresponds to DC component of the reflected light of the main beam under the first laser power and the fourth value corresponds to DC component of the reflected light of the main beam under the second laser power.

6. The method of claim 1, wherein the step of measuring the reflected light of the side beam under the first laser power comprises:
converting the reflected light of the side beam into a plurality of first digital values; and
averaging the plurality of first digital values to generate the first value.

7. The method of claim 1, wherein the step of measuring the reflected light of the main beam under the first laser power comprises:
converting the reflected light of the main beam into a plurality of second digital values; and
averaging the plurality of second digital values to generate the second value.

8. The method of claim 1, wherein the step of measuring the reflected light of the side beam under the second laser power comprises:
converting the reflected light of the side beam into a plurality of third digital values; and
averaging the plurality of third digital values to generate the third value.

9. The method of claim 1, wherein the step of measuring the reflected light of the main beam under the second laser power comprises:
converting the reflected light of the main beam into a plurality of fourth digital values; and
averaging the plurality of fourth digital values to generate the fourth value.

10. An optical storage device for determining a relationship between a main beam and a side beam, the optical storage device comprising:
a measuring module for measuring reflected light of the side beam under a first laser power to generate a first value, measuring reflected light of the main beam under the first laser power to generate a second value, measuring reflected light of the side beam under a second laser power to generate a third value, and measuring reflected light of the main beam under the second laser power to generate a fourth value; and
a decision unit coupled to the measuring module for determining a ratio of the main beam to the side beam according to the first, second, third, and fourth values.

11. The optical storage device of claim 10, wherein the decision unit calculates a first difference between the first and third values and a second difference between the second and fourth values, and then calculates the ratio according to the first and second differences.

12. The optical storage device of claim 11, wherein the decision unit divides the first difference by the second difference to generate the ratio.

13. The optical storage device of claim 10, wherein the first value corresponds to DC component of the reflected light of the side beam under the first laser power, and the third value corresponds to DC component of the reflected light of the side beam under the second laser power.

14. The optical storage device of claim 10, wherein the second value corresponds to DC component of the reflected light of the main beam under the first laser power, and the fourth value corresponds to DC component of the reflected light of the main beam under the second laser power.

15. The optical storage device of claim 10, wherein the measuring module comprises:
a sensing device for sensing the reflected light of the side beam under the first laser power to generate a first analog signal;
an analog-to-digital converter (ADC) coupled to the sensing device for converting the first analog signal into a plurality of first digital values; and
a calculating unit coupled to the ADC for averaging the plurality of first digital values to generate the first value.

16. The optical storage device of claim 10, wherein the measuring module comprises:
a sensing device for sensing the reflected light of the main beam under the first laser power to generate a second analog signal;
an ADC coupled to the sensing device for converting the second analog signal into a plurality of second digital values; and
a calculating unit coupled to the ADC for averaging the plurality of second digital values to generate the second value.

17. The optical storage device of claim 10, wherein the measuring module comprises:
a sensing device for sensing the reflected light of the side beam under the second laser power to generate a third analog signal;
an ADC coupled to the sensing device for converting the third analog signal into a plurality of third digital values; and
a calculating unit coupled to the ADC for averaging the plurality of third digital values to generate the third value.

18. The optical storage device of claim 10, wherein the measuring module comprises:
a sensing device for sensing the reflected light of the main beam under the second laser power to generate a fourth analog signal;
an ADC coupled to the sensing device for converting the fourth analog signal into a plurality of fourth digital values; and
a calculating unit coupled to the ADC for averaging the plurality of fourth digital values to generate the fourth value.

19. A method for generating at lease one servo control signal of an optical storage device, comprising:
measuring reflected light of a side beam under a first laser power to generate a first value;
measuring reflected light of a main beam under the first laser power to generate a second value;
measuring reflected light of the side beam under a second laser power to generate a third value;
measuring reflected light of the main beam under the second laser power to generate a fourth value;
determining a ratio of the main beam to the side beam according to the first, second, third, and fourth values;
generating a first push-pull signal according to reflected light of the main beam;
generating a second push-pull signal according to reflected light of the side beam; and
generating the servo control signal according to the first push-pull signal, the second push-pull signal, and the ratio.

20. The method of claim 19, wherein the ratio is a synthesized gain of the second push-pull signal with respect to the first push-pull signal.

21. The method of claim 19, wherein the at least one servo control signal is selected from a group consisting of a tracking error (TE) signal, a focusing error (FE) signal, and a differential radial contrast (DRC) signal.

22. An optical storage device for generating at lease one servo control signal, the optical storage device comprising:
a measuring module for measuring reflected light of a side beam under a first laser power to generate a first value, measuring reflected light of a main beam under the first laser power to generate a second value, measuring reflected light of the side beam under a second laser power to generate a third value, and measuring reflected light of the main beam under the second laser power to generate a fourth value;
a decision unit coupled to the measuring module for determining a ratio of the main beam to the side beam according to the first, second, third, and fourth values;
a first push-pull signal generator for generating a first push-pull signal according to reflected light of the main beam;
a second push-pull signal generator for generating a second push-pull signal according to reflected light of the side beam; and
a servo control signal generator for generating the servo control signal according to the first push-pull signal, the second push-pull signal, and the ratio.

23. The optical storage device of claim 22, wherein the ratio is a synthesized gain of the second push-pull signal with respect to the first push-pull signal.

24. The optical storage device of claim 22, wherein the at least one servo control signal is selected from a group consisting of a tracking error (TE) signal, a focusing error (FE) signal, and a differential radial contrast (DRC) signal.
